(19) United States
(12) Patent Application Publication
(10) Pub. No.: US 2017/0252658 A1
(43) Pub. Date: Sep. 7, 2017

(54) SEAT APPARATUS

(71) Applicant: Figment Productions Limited, Guildford (GB)

(72) Inventor: Simon Paul Reveley, Guildford (GB)

(73) Assignee: Figment Productions Limited, Guildford (GB)

(21) Appl. No.: 15/253,191

(22) Filed: Aug. 31, 2016

(30) Foreign Application Priority Data
Mar. 1, 2016 (GB) GB1603562.8

(51) Int. Cl. A63G 31/00; G06F 3/01; B60R 21/02

(52) U.S. Cl. CPC A63G 31/00; B60R 21/02; G06F 3/011; B60R 2021/028; G06F 3/16

(57) ABSTRACT

Provided is a seat having a headset, wherein the headset may include a headband. The headset includes a tether cable to secure the headset directly or indirectly to the seat. The seat may form part of a vehicle such as, e.g., a roller coaster vehicle.

### CROSS-REFERENCE TO RELATED APPLICATIONS

This patent application claims the benefit of Great Britain Patent Application No. 1603562.8, filed Mar. 1, 2016, which is incorporated herein by reference.

### BACKGROUND OF THE INVENTION

Seats for roller coaster vehicles have been known for some time. A recent innovation relating to roller coasters is to provide a virtual reality experience for the passenger. Virtual reality headsets may be used to project images to the passenger. In such cases, the images seen on a screen of a virtual reality headset, and optionally also sound effects, are synchronized with the movement of the roller coaster vehicle. Examples of virtual reality roller coaster concepts are described in the specifications of GB1516710.9, WO2016/023817 and U.S. Pat. No. 6,179,619.

It is desirable to provide a virtual reality headset for each seat of the roller coaster vehicle. However, problems exist with respect to securing of the headset, for example, in circumstances where the seat is unoccupied or in the event that the headset becomes detached from a user. The seat of the present invention addresses such problems.

### BRIEF SUMMARY OF THE INVENTION

The present invention relates to a seat, for example a seat for use with a roller coaster vehicle. The seat of the present invention includes a headset and at least one tether cable, wherein one end of the tether cable is secured to the headset and the other end of the tether cable is secured to the seat. The seat of the present invention may include a passenger receiving portion and a support frame configured to support the passenger receiving portion. The headset may include a screen configured to display images to the wearer of the headset. The headset also may include one or more lenses located adjacent to the screen. The screen may be configured to display computer-generated images. The headset also may include one or more speakers, for example, speakers adapted to provide sounds to the wearer, for example a commentary and/or sound effects. The headset additionally may include a detachable cover, for example, a detachable cover that is water resistant. In one embodiment, the headset further includes, or is connected to, a controller configured to control images displayed on the screen. The controller may constitute part of the headset or may be separate from the headset, and the headset may be electrically connected to the headset, for example, via a control cable. The controller also may include a user interface. The seat of the present invention also may include a pouch configured to receive the headset therein. The pouch may include a latchable cover. The seat of the present invention additionally may include a passenger restraining element, for example, a passenger restraining element that includes at least one rigid bar. If the seat includes a passenger restraining element, the tether cable may be secured to the passenger restraining element. If the seat includes a pouch, the pouch may be secured to the passenger restraining element. In one embodiment, the seat of the present invention includes a passenger receiving portion with a passenger restraining element, which is movable relative to the passenger receiving portion such that the passenger restraining element has a first configuration in which the user is restrained in the passenger receiving portion by the restraining element and a second configuration in which the user is not restrained in the passenger receiving portion. In another embodiment, the seat of the present invention includes an electrical power supply and a power supply cable, wherein the power supply cable electrically connects the power supply to the headset.

The present invention also provides a vehicle, which includes the seat of the present invention. In one embodiment, the vehicle of the present invention is a roller coaster vehicle configured to travel along a continuous track.

### BRIEF DESCRIPTION OF THE SEVERAL VIEWS OF THE DRAWINGS

FIG. 1 is a front elevational representation of a pair of adjacent seats, which may be used in the seat of the invention.

FIG. 2 is a perspective view of a passenger restraining element, which may be used in the seat of the invention.

FIG. 3 is a perspective view of a headset, which may be used in the seat of the invention.

FIG. 4 is a perspective view of exemplary seats mounted in a roller coaster vehicle.

### DETAILED DESCRIPTION OF THE INVENTION

According to a first aspect of the invention, there is provided a seat having a headset secured thereto via at least one tether cable, wherein the headset has secured thereto one end of the at least one tether cable and the other end of the at least one tether cable is secured to the seat.

By having the headset secured to the seat via a tether cable, the headset remains attached to the seat when not in use. Furthermore, the tether cable prevents the headset from being removed intentionally or unintentionally from the seat.

The term “tether cable” as used herein is intended to cover all flexible elongate elements that have sufficient strength and integrity to prevent the headset from breaking free of the cable. Thus, the tether cable may be substantially inelastic, such as, e.g., a metal cable, or it may be capable of elastic deformation, such as, e.g., a cable formed from a polymeric material. Furthermore, the cable may be formed from a single strand of material or from multiple strands of material braided together. Optionally, the cable is coated, such as with a polymeric coating. Such a coating may be adapted to prevent or minimize damage or degradation to the tether cable.

The tether cable may be coupled in any way that is suitable for preventing the headset from becoming separated from the seat. For example, the headset may be non-releasably coupled to the tether cable. Alternatively, the tether cable may be releasably secured to the headset, for example, via a locking element, wherein the locking element has a locked configuration in which detachment of the tether cable from the headset is prevented and an unlocked configuration in which the tether cable may be released from the headset.

The headset suitably includes a headband, for example, a headband adapted to releasably secure the headset to the head of a user. The tether cable may be secured to the headband of the headset.

In an embodiment of the invention, the headset is secured by a pair of tether cables. The tether cables may be secured, for example, to opposite sides of the headset. In embodiments in which the headset includes a headband, the tether cables may be secured, for example, to opposite sides of the headband. A pair of tether cables provides better control of the headset in the event that the headset becomes loose.

It will be appreciated that the seat of the invention may include any suitable seat. However, the seat preferably forms part of a vehicle, especially a vehicle that may be subject to relatively high G-forces. An example of such a vehicle is a roller coaster vehicle, i.e., a vehicle which is configured to travel along the track of a roller coaster. Other such vehicles may include those which move about a fixed point or axis in two or three dimensions. Such a vehicle may include a plurality of seats. Thus, a second aspect of the invention may provide a vehicle which includes two or more seats as defined herein.

In an embodiment of the invention, the headset includes a screen which is configured to display images, which are suitably pre-programmed images. The headset may further include one or more lenses located in front of the screen (e.g., between the screen and the eyes of a user in use). The use of lenses allows the headset to provide different user-experiences. The screen may be a flat screen, and may furthermore be removable from the headset. This allows the screen to be replaced in the headset in the event that it becomes damaged or faulty.

The screen and optional lens(es) may define a virtual reality screen or an augmented reality screen. It will be appreciated that a virtual reality screen typically displays a computer-generated image, whereas an augmented reality screen overlies a true-life background with additional, computer-generated images or content, thus providing a mixture of real images and computer-generated images. Virtual reality headsets are now becoming commercially available, such as the Samsung™ Gear VR headset and the Oculus Rift headset. Such commercially available headsets may be adapted for use in the present invention.

In order to provide a more immersive experience for the user, the headset may include one or more speakers. The speakers may be in addition to or as an alternative to the screen. Thus, the headset may provide images, sounds (for example a commentary or sound effects) or both images and sounds to the user.

In embodiments in which the vehicle may be used outdoors and the seat may be uncovered, the headset may include a detachable cover. The detachable cover may be water resistant or water proof. Additionally or alternatively the detachable cover may prevent or minimize the ingress of dirt or dust into the headset in use, thereby protecting the headset from contamination and/or damage.

In embodiments where the seat forms part of a roller coaster vehicle, the seat typically includes a restraining element. Such restraining elements are provided to prevent passengers from being thrown from or around the vehicle in use. Optionally, the tether cable is secured to the seat via the restraining element. The restraining element is typically movable relative to a passenger receiving portion of the seat to permit easier access to the passenger receiving portion. By securing the tether cable to the restraining element, the tether cable is capable of moving with the restraining element without interfering with a user's access to the passenger receiving portion of the seat.

Typically, the restraining element includes at least one rigid bar member and the rigid bar member may be movable relative to the passenger receiving portion of the seat. For example, the rigid bar member may be rotationally coupled relative to the passenger receiving portion of the seat or it may be hingedly coupled relative to the passenger receiving portion of the seat. Where the restraining element is movable relative to the passenger receiving portion of the seat, it may have a first configuration in which a user is restrained in the passenger receiving portion of the seat by the restraining element, and a second configuration in which the user is not restrained or is released. By having the headset tether cable secured to the seat via the restraining element, the headset may be located adjacent to the user when the restraining element is in its first configuration and it may be moved away from the user when the restraining element is in its second configuration so as not to obstruct access to the passenger receiving portion of the seat before and after the ride.

The seat may include a container or a pouch which is configured to receive therein the headset. For example, the restraining element may carry the pouch. In this way, if the seat is unoccupied, the headset may be securely retained within the container or pouch during a ride and not be thrown around as a result of the physical forces generated by and/or experienced by the vehicle. To prevent the undesired egress of the headset from the container or pouch during the motion of the vehicle in use, the container or pouch may include a latchable cover or lid. The cover or lid may be latched via a fastener, such as a zip fastener or a hook and eye-type fastener (e.g. a fastener available under the trademark Velcro™. Alternatively, the pouch or container may comprise a main body portion and a cover, wherein the main body portion carries or defines one part of a two-part latch and the cover carries or defines a second part of the two-part latch, wherein the cover may be secured to the main body portion when the latch is closed and the cover may be opened to provide access to the pouch or container when the latch is released.

In an embodiment of the invention, the seat comprises a user or passenger receiving portion and a frame, wherein the passenger receiving portion is supported by the frame. The frame may form part of the vehicle, for example, in embodiments in which the seat forms a part of a vehicle.

The seat may include an electrical power supply and a power supply cable configured to electrically connect the headset to the power supply. The power supply cable may be located adjacent to the tether cable or a portion thereof. The electrical power supply may provide electrical power to two or more seats.

The headset suitably further includes a controller which controls images displayed on the screen of the headset (e.g., in embodiments where the headset includes a screen) and/or controls sounds emitted from one or more speakers (e.g., in embodiments where the headset includes one or more speakers). The controller may also include one or more motion sensors to determine the physical location of the seat in use. In embodiments in which the seat forms part of a roller coaster vehicle, the headset transmits content visually and/or audibly to a user and the roller coaster vehicle circulates about a track, the controller may include a user interface. The user interface may allow a user to select certain pre-programmed content and/or it may allow the user to re-set the content to the beginning for the next ride. Thus, the user interface may comprise a touchscreen and/or one or more buttons. The user in this case may be a passenger in the seat. Additionally or alternatively, the user may be a host or operator of a vehicle which includes one or more seats.

The controller may form a part of the headset, it may be carried by the seat and connected to the headset via a wired or wireless connection, or it may be remote from the seat, in which case, the headset or the seat may include a receiver which is adapted or configured to receive signals from the controller.

In an embodiment of the invention, the controller may be carried by the seat and suitably electrically connected to the headset via a control cable. The control cable may be located adjacent to a tether cable or a portion thereof. In embodiments in which the headset includes both a power supply cable and a control cable, the cables may be located adjacent to each other or a single common cable may be configured to act as both a power supply cable and a control cable, and may be located adjacent to a tether cable or a portion thereof. In embodiments in which a single common cable provides both power and control signals to the headset, the electrical power source may be connected to the controller and the headset may be powered from the electrical power source via the controller.

One of ordinary skill in the art will appreciate that the features described and defined in connection with the aspects of the invention and the embodiments thereof may be combined in any suitable combination, regardless of whether the specific combination is expressly described herein. Thus, all such combinations are considered to be made available to the skilled person.

For the avoidance of doubt, the skilled person will appreciate that in this specification, the terms “up”, “down”, “front”, “rear”, “upper”, “lower”, “width”, etc. refer to the orientation of the components as found in the example when installed for normal use, for example, as shown in the Figures.

An embodiment of the invention will now be described, by way of example only, with reference to the accompanying drawings in which:

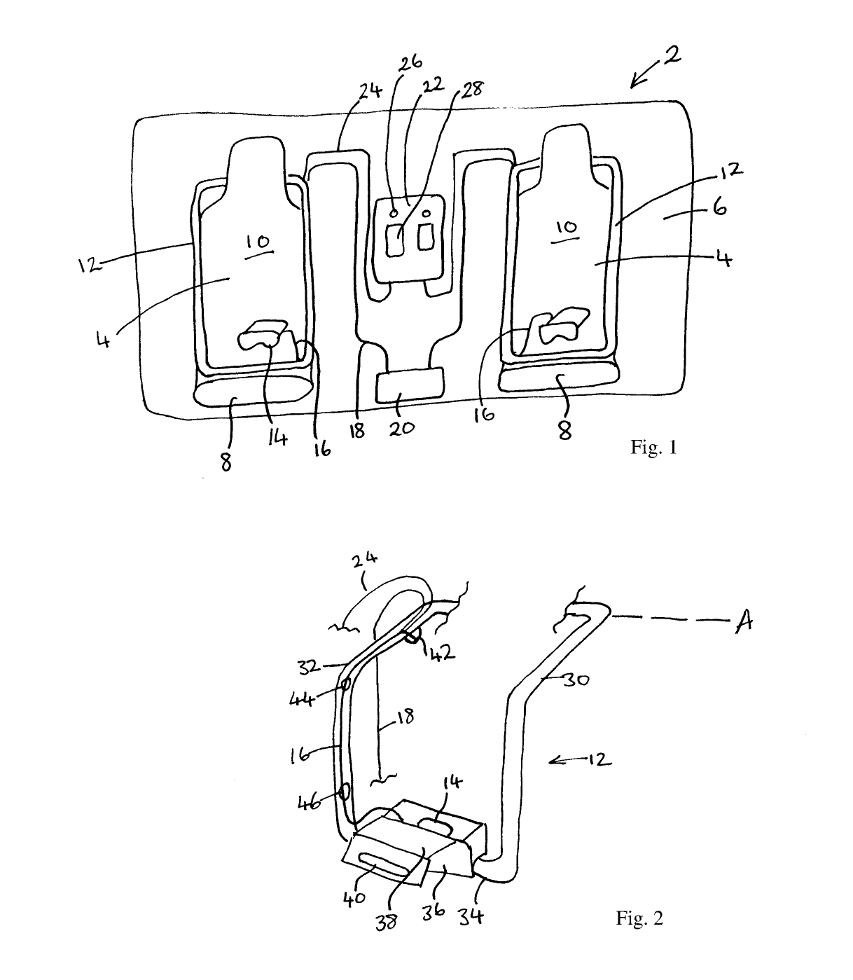

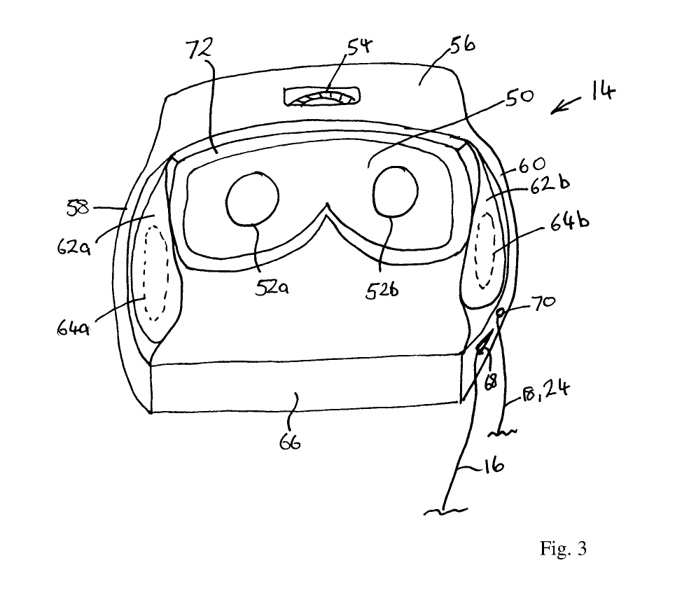

FIG. 1 shows a pair of seats 2, wherein the pair of seats 2 is formed by a pair of passenger receiving portions 4 supported by a common frame support 6. Each passenger receiving portion 4 comprises a seat squab 8 and a shaped upright back support 10. It also includes a passenger restraining element 12, which is shown in FIG. 2 and discussed in more detail below.

Each passenger receiving portion 4 has associated with it a headset 14. The headset 14 is shown in FIG. 3 and discussed in more detail below. The headset is secured to the respective passenger receiving portion 4 by a tether cable 16. The headset is powered via a power cable 18 which connects the headset to a rechargeable battery pack 20. The rechargeable battery pack 20 powers both of the headsets 14 that are associated with the seat 2.

A controller 22 is carried by the common frame structure 6 and is connected to each of the headsets 14 via a control cable 24. The controller 22 includes a control system (not shown) for each headset 14 that allows the content supplied to the respective headset 14 to be controlled. For example, the controller 22 may control video content supplied to the headset 14 and/or an audible content supplied to the headset 14.

The controller 22 includes a re-set button 26 which allows a user to re-set the content prior to the subsequent ride and a touchscreen user interface 28 that permits a user to modify or alter the content transmitted to the headset 14. The user in this case may be a passenger about to ride on the roller coaster or it may be an operator or host associated with the ride or both. Thus, the passenger may select the desired content before sitting in the seat or an operator/host may re-set the content prior to the start of the ride and/or alter the content or user-experience once the passenger is seated.

FIG. 2 shows a more detailed representation of the passenger restraining element 12. The restraining element 12 has a pair of opposed shoulder restraint members 30, 32 in the form of shaped rigid bars. The upper portions of the shoulder restraint members 30, 32 are coupled to a pivot mechanism (not shown) located within the seat frame 6. The pivot mechanism causes the shoulder restraint members 30, 32 to pivot about a pivot axis A to define an access configuration, in which the restraint members 30, 32 are moved away from the back support 10, and a restraining configuration in which the restraint members restrain a passenger against movement away from the passenger receiving portion 4 of the seat 2. Such pivot mechanisms are well known in the field of roller coaster vehicles.

A lap member 34, also in the form of a rigid bar, joins the lower ends of the shoulder restraint members 30, 32. The lap member 34 carries a pouch 36 which defines therein a cavity which is sized to receive therein the headset 14. The pouch is reversibly closable via a flap 38 and may be latched in its closed configuration via a hook and eye fastener (e.g. a Velcro™ fastener). As shown in FIG. 2, one part 40 of the hook and eye fastener is secured to the flap 38 and the other part (not shown) is secured to a portion of the pouch 36 which is adjacent to the distal end of the flap 38 in its closed configuration.

One of the shoulder restraint members 32 includes a tether cable anchor 42 to which the tether cable 16 is anchored. The shoulder restraint member 32 further carries a pair of tether cable guide elements 44, 46 which are used to route the tether cable 16 along the shoulder restraint member 32.

The power cable 18 and the control cable 24 are coupled to the tether cable 16 at a point adjacent to where the tether cable 16 is anchored to the cable anchor 42. In this way, the tether cable 16, the power cable 18 and the control cable 24 are all routed together along the shoulder restraint member 32 before being operably connected to the headset 14.

Detachable padded covers (not shown in FIG. 2 for reasons of clarity) are located over shoulder restraint members 30 and 32 and routed cables 16, 18, 24. A lower portion of the pouch 36 may be padded or a separate lap member padded cover may be provided to cover the lap member 34 of the restraining element 12.

FIG. 3 shows a headset 14 for use with the invention. The headset includes a commercially available virtual reality module 50, such as a Samsung^{TM} Gear VR. Such modules include a pair of lenses 52a, 52b to focus the visual content displayed on a screen (not shown) of the module 50 and a focus wheel 54 to vary the distance of the lenses 52a, 52b from the screen, thereby adjusting the focus of the lenses for the individual user.

The virtual reality module 50 is located within a protective cover 56 made from a water resistant material. The protective cover 56 entirely envelopes the virtual reality module 50 with the exception of a small aperture defined in an upper portion of the cover 56 to permit access to the focus wheel 54 of the virtual reality module 50. The cover 56 includes a pair of side portions 58, 60 which extend rearwardly from the module 50. The side portions 58, 60 each define a cavity 62a, 62b within which are located a respective one of a pair of speakers indicated by the dashed lines 64a, 64b. While, the outwardly facing surfaces of the side portions 58, 60 are formed from water resistant material, the inwardly facing surfaces of the side portions 58, 60 are formed from a softer, mesh material, as the inwardly facing surfaces of the side portions 58, 60 will be in contact with the sides of a user's head in use. In addition, the mesh material permits better sound transmission from the speakers 64a, 64b.

The speakers 64a, 64b are electrically connected to the virtual reality module 50.

The distal ends of the side portions 58, 60 are joined by a strap 66 formed from an elastomeric material. The two side portions 58, 60 and the strap 66 together define a headband, namely a portion of the headset 14 which in use is located around the head of a user.

One side portion (side portion 60 as shown in FIG. 3) has an attachment point 68 to which is secured one end of the tether cable 16. In this way, even if the headset 14 becomes dislodged from the head of a user in use, it will remain attached to the seat 2 via the tether cable 16 being anchored at its other end to the shoulder restraint member 32. The side portion 60 further includes a cable aperture 70 through which the control and power cables 18, 24 pass for electrical connection to the virtual reality module 50.

A replaceable hygiene component 72 is releasably attached to the front of the virtual reality module 50. Such an arrangement allows each new user to have a fresh hygiene component 72 located between the user's face and the virtual reality module 50. This should prevent or mitigate the transmission of skin-borne bacteria between users. The hygiene component 72 is replaced after each use of the headset 14. The hygiene components may be disposable (i.e. they may be single use only components) or they may be capable of sterilization and therefore are re-usable.

It will be appreciated that for some commercially available virtual reality modules 50, the power cable and the control cable may be formed by a common cable which is configured to provide both power and control signals to the module 50. In such an embodiment, the power cables 18 may connect the battery pack 20 to the controller 22 and the control cables 24 may provide both electrical power and control signals from the controller 22 to the headset 14.

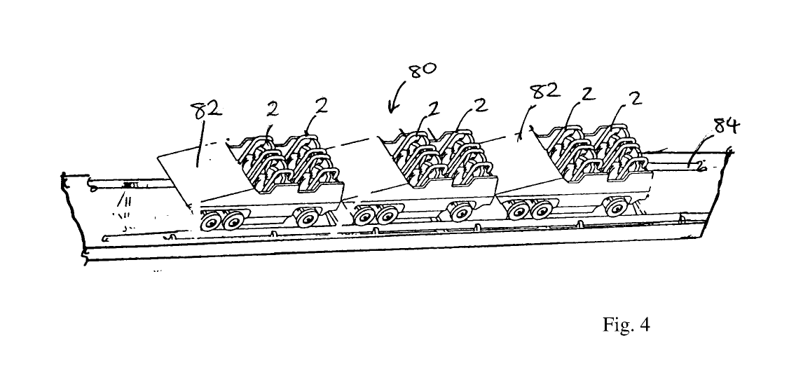

FIG. 4 shows the seat 2 installed in a roller coaster vehicle 80. The roller coaster vehicle 80 comprises a train of three roller coaster units 82, wherein each roller coaster unit 82 includes two seats 2, each of which comprise a pair of passenger receiving portions 4 carried by a common frame support 6. Thus, each roller coaster unit 82 is able to accommodate four passengers.

The roller coaster vehicle is configured to run on a continuous track 84, which is well known in the field of roller coasters.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A seat comprising a headset and a tether cable, wherein one end of the tether cable is secured to the headset and the other end of the tether cable is secured to the seat.

2. A seat according to claim 1, wherein the seat comprises a passenger receiving portion and a support frame configured to support the passenger receiving portion.

3. A seat according to claim 1, wherein the headset comprises a screen configured to display images to the wearer of the headset.

4. A seat according to claim 3, wherein the headset comprises one or more lenses located adjacent to the screen.

5. A seat according to claim 3, wherein the screen is configured to display computer-generated images.

6. A seat according to claim 5, wherein the headset further comprises, or is connected to, a controller configured to control the images displayed on the screen.

7. A seat according to claim 6, wherein the controller is separate from the headset and the headset is electrically connected to the headset via a control cable.

8. A seat according to claim 6, wherein the controller comprises a user interface.

9. A seat according to claim 1, wherein the headset comprises one or more speakers.

10. A seat according to claim 1, wherein the headset comprises a detachable cover.

11. A seat according to claim 10, wherein the detachable cover is water resistant.

12. A seat according to claim 1, wherein the seat comprises a pouch configured to receive therein the headset.

13. A seat according to claim 12, wherein the pouch comprises a latchable cover.

14. A seat according to claim 1, wherein the seat comprises a passenger restraining element and the tether cable is secured to the seat via the passenger restraining element.

15. A seat according to claim 14, wherein the passenger restraining element comprises at least one rigid bar.

16. A seat according to claim 14, wherein the seat comprises a passenger receiving portion and the restraining element is movable relative to the passenger receiving portion such that it has a first configuration in which the user is restrained in the passenger receiving portion by the restraining element and a second configuration in which the user is not restrained in the passenger receiving portion.

17. A seat according to claim 14, wherein the seat further comprises a pouch, wherein the pouch is carried by the passenger restraining element.

18. A seat according to claim 1, wherein the seat comprises an electrical power supply and a power supply cable, wherein the power supply cable electrically connects the power supply to the headset.

19. A vehicle including a seat according to claim 1.

20. A vehicle according to claim 19, wherein the vehicle is a roller coaster vehicle configured to travel along a continuous track.
